(19) United States
(12) Patent Application Publication
(10) Pub. No.: US 2024/0300507 A1
(43) Pub. Date: Sep. 12, 2024

(54) Integrated System for Monitoring and Control of Vehicle and Dump Body for Safe Operation of Vehicle by Operator

(71) Applicant: Charles T Pishock, Schutlkill Haven, PA (US)

(72) Inventor: Charles T Pishock, Schutlkill Haven, PA (US)

(21) Appl. No.: 18/118,990

(22) Filed: Mar. 8, 2023

(51) Int. Cl. B60W 50/14; B60K 35/00

(52) U.S. Cl. CPC B60W 50/14; B60K 35/00; B60K 35/10; B60K 35/22; B60K 35/28; B60K 2360/119; B60K 2360/16; B60W 2050/146; B60W 2300/125

(57) ABSTRACT

An integrated truck monitor and dump body controller that monitors sensor information of truck functions, dump body position and stability, with the ability to operate and control the dump body from the in-cab integrated truck monitor and dump body controller by the operator through an interactive display.

### BACKGROUND OF THE INVENTION

This invention resides in the field of systems that monitor vehicle status to provide real time vehicle status to an operator for the purpose of the safe operation of vehicle systems for protecting the load, processing the load, and providing the operator with an integrated status and view while operating various vehicle systems. The integrated system of the present invention provides to an operator seated in the vehicle cab a unique ability to monitor vehicle status while preparing to accept a load, for protecting the load while in transit, and for offloading the load at its destination.

Various stand alone systems for monitoring vehicle status and load bed status and control have been described in a number of patents and patent publications. The following highlights and describes in limited fashion the more relevant of these earlier devices. A first group of disclosures concern the control of the load bed, or dump body to provide to the operator sensor information of the incline of the dump body in order to control the hydraulic lifting mechanism of the dump body. These systems are described in U.S. Patent Application Publication Nos. US2021/0261032 A1 [Hayes, et al.] and US 2017/0144578 A1 [Thompson, et al.] and in World Intellectual Property Organization International Application Publication Nos. WO 2020/207599 A1 [Hagerskan] and WO 2016/142196 A1 [Baldys, et al.] The described systems all provide monitoring of the tilt angle of the dump body load bed and monitoring and control of the hydraulic system utilized for the raising and lowering of the dump body. Some of the systems also provide both tilt and roll angle sensing to prevent vehicle rollover during offloading with the dump body upwardly inclined for depositing its load at a designated location.

There are also several relevant disclosures in patent and patent application publications that describe various systems for sensing and monitoring the tilt angle of the dump body load bed while simultaneously sensing and monitoring the rollover angle limits of the raised dump body for the vehicle. Several of the more relevant publications for monitoring tilt angle and rollover angle of the vehicle and dump body are U.S. Pat. No. 4,682,145 [Brawner, Jr.], U.S. Pat. No. 5,742,228 [Levy], and U.S. Pat. No. 6,128,076 [Sackett] and U.S. Patent Application Publication Nos. US 2020/0207249 A1 [Wink], US 2018/0111537 A1 [Baldys, et al.], US 2016/0257236 A1 [Baldys, et al.], US 2012/0239257 A1 [Ichinose, et. al.] These publications generally describe the sensor and monitoring systems by providing longitudinal and lateral level sensors and roll over angle limit measurements and display those sensed values to an operator. The sensors are variously placed on both the vehicle frame and the dump body to provide the tilt and/or angular monitoring measurements. An additional relevant patent document is Spanish Patent ES-2710376-T3 [Fry, et al.] that describes automatic signaling to an operator that an inclination angle of the dump body has been exceeded and that vehicle braking should be engaged.

There are also earlier descriptions of other on-board systems such as flexible covering extension and retraction systems. U.S. Pat. No. 8,056,955 [Schmeichel] and U.S. Patent Application No. US 2019/0217691 A1 [Eggers] describe the deployment of a flexible cover, its alignment retention during deployment and its retraction. Turkish Patent Application Publication No. TR-201902796 A2 [Selcuk] adds to the other disclosures of flexible cover controls sensors that provide the status of the cover being open or closed and a vehicle speed sensing monitor to prevent deployment of the cover when the vehicle speed is too great. Finally, Korean Patent Application Publication No. KR-20050052349-A [Nakamura] describes an in-cab visual display of vehicle engine state, i.e., various gauge and vehicle operational function displays.

Starting with Nakamura, which provides to the operator vehicle status information on a visual in-cab display, there is lacking any control functions for the operator to engage. While there are a number of vehicle and system status displays, there are no control functions available to the operator on the display. The operator must resort to the actual vehicle controls to achieve vehicle or operational functional movement. Further, not one of the various patent publications creates an integrated environment that permits the monitoring and control of various vehicle functions from a single combination monitoring and control system. The various patent publications merely suggest the manner of sensing and/or monitoring but without the capability of providing the operator with more than one monitoring function or the ability to control operational functions while continuing to monitor vehicle and operational movement.

It is, therefore, one object of the present invention to provide an integrated combination or unified monitoring and control system for the operation of the vehicle and of the on-board functioning apparatus in a single interactive display unit. It is a further object of the present invention to permit an operator while remaining in the vehicle cab to view the functioning apparatus while monitoring the status of that apparatus and the vehicle. It is a still further object of the present invention to integrate vehicle engine and operational status data and display such information to the operator such that the operator can appropriately judge when and how to initiate on-board systems to facilitate loading and unloading of the vehicle.

Other objects will appear hereinafter.

### SUMMARY OF THE INVENTION

The present invention acts to organize and coordinate vehicle and dump body sensors for display in the operator's view on an in-cab display. The in-cab display is part of the integrated truck monitor and dump body controller of the present invention that monitors sensor information of truck functions, dump body position and stability, and the ability to operate and control the dump body from the in-cab integrated truck monitor and dump body controller by the operator through the interactive display. The interactive display provides both visual sensor information about the status of a plurality of truck and dump body functions and position status of a plurality of operable elements, as well as the ability of the operator to control the truck and dump body functions while remaining in the cab of the truck.

The present invention is an apparatus that combines vehicle operational status and control in a single interactive sensing, control and display unit including the following elements. First, a truck with dump body or a truck with attached dump trailer where all elements can be monitored and controlled form an operator's seat in the truck or cab. An interactive visual display mounted in the truck or cab in close visual proximity to the operator's seat having one or more screens for displaying vehicle parametric information including both truck and dump body or dump trailer operational status, selectable control functions for various operable equipment on the dump body or dump trailer, and selectable camera views of an immediate area surrounding the vehicle and the dump body or dump trailer. The interactive visual display includes a special purpose computing device for collecting a plurality of sensor information from the vehicle including operating parameters of the truck and operating parameters for the dump body or dump trailer and displaying the sensor and operating parameter status on the interactive visual display screen. The interactive visual display also includes icons for controlling selectable functions of various operable equipment on the dump body or dump trailer from visual controls displayed on one or more screens of said interactive visual display.

The operator is able select for viewing the one or more screens for monitoring vehicle parameters and sensor information, controlling dump body or dump trailer functions, and camera views. The one or more screens available for viewing on interactive visual display may be arranged to display vehicle parameter and sensor information and dump body or dump trailer control functions on a single screen. An alternative viewing screen set up for the one or more screens of the interactive visual display may be arranged to display vehicle parameter and sensor information, dump body or dump trailer control functions, and one or more camera views on a single screen.

The plurality of sensor information collected from said vehicle including operating parameters of said truck may be selected from the group consisting of body angle sensor, air suspension pressure sensor, air supply pressure sensor, and hydraulic pressure sensor. Further, the plurality of sensor information from said vehicle including operating parameters for said dump body or dump trailer may be selected from the group consisting of dump body or trailer angle sensor, air suspension pressure sensor, air supply pressure sensor, hydraulic pressure sensor, tailgate pressure sensor, high lift tailgate sensor, tailgate lock position sensor, dump body position sensor, load cover position sensor, and one or more axle position sensors. The lists are not exhaustive as other parameters, sensors, and control functions can be added.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a side view of a truck with mounted dump body showing the placement of the various sensors, cameras and controls and the integrated truck monitor and dump body controller of the present invention.

FIG. 2 is a side view of a dump body trailer and cab tractor showing the placement of the various sensors, cameras and controls and the integrated truck monitor and dump body controller of the present invention.

FIG. 3 is a flow diagram of the integrated truck monitor and dump body controller of the present invention showing the various sensor and control monitoring circuits of the controller area network.

FIG. 4 is a view of the in cab interactive display of the integrated truck monitor and dump body controller of the present invention with selectors for the interactive screen and exterior cameras.

FIG. 5 is a circuit diagram of the integrated truck monitor and dump body controller of the present invention showing circuit connections between the in-cab interactive display and the integrated truck monitor and dump body controller with the various sensors and function controllers arrayed around the truck and dump body.

FIGS. 6A, 6B show a circuit diagram of the sensor and function control circuits between the in-cab interactive display and the integrated truck monitor and dump body controller with the various sensors and function controllers arrayed around the truck and dump body.

### DETAILED DESCRIPTION OF THE PREFERRED EMBODIMENTS

The following detailed description is of the best presently contemplated mode of carrying out the invention. The description is not intended in a limiting sense and is made solely for the purpose of illustrating the general principles of the invention. The various features and advantages of the present invention may be more readily understood with reference to the following detailed description taken in conjunction with the accompanying drawings.

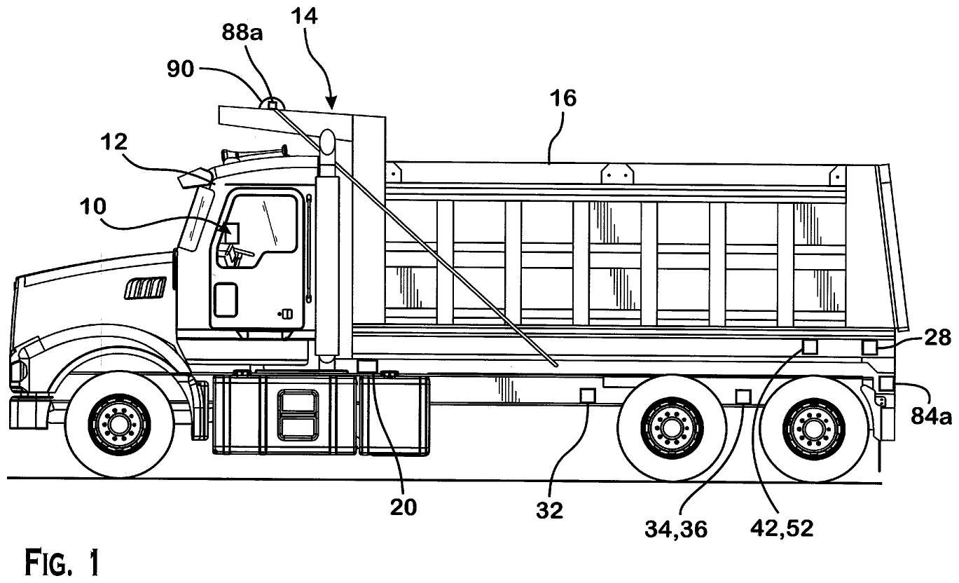

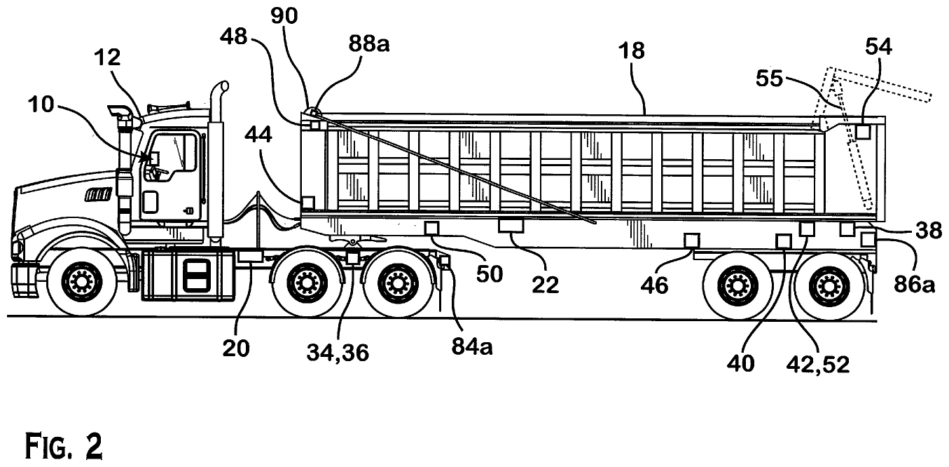

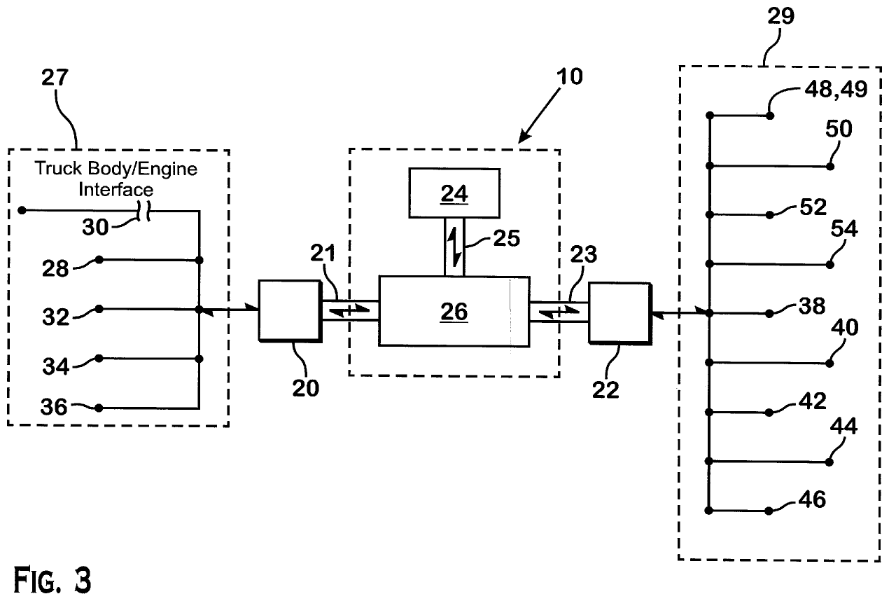

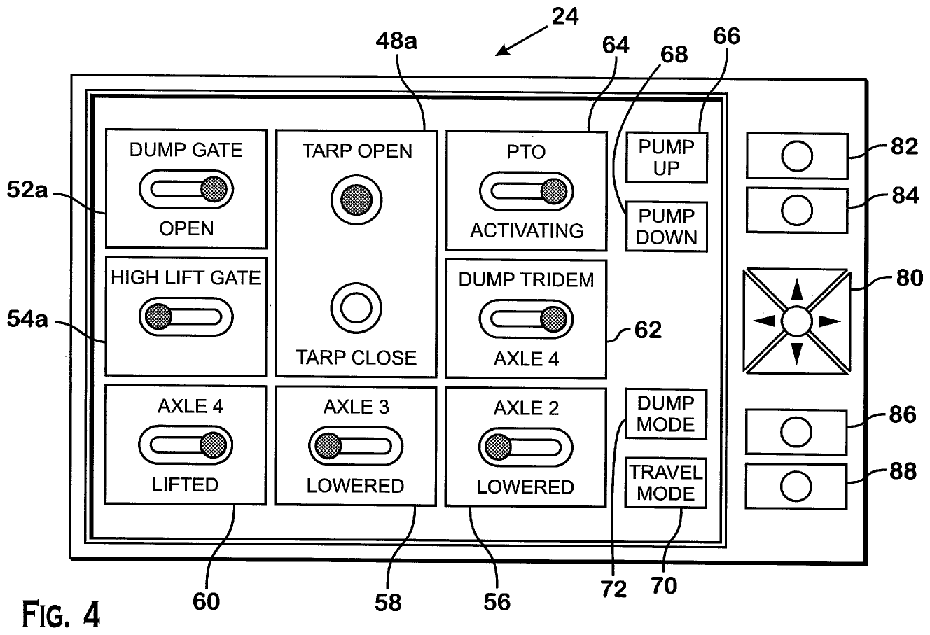

Referring now to the drawings in detail, where like numerals refer to like parts or elements, there is shown in FIGS. 1 and 2 a truck with a mounted dump body and a truck cab with an attached trailer carrying a dump body, respectively. With reference to FIG. 1, the integrated truck monitor and dump body controller 10 is located within the truck cab 12 of the dump truck 14 in full view and reach of an operator. The integrated truck monitor and dump body controller 10 provides both sensor/monitor status of vehicle functions and dump body 16 status and control on a single interactive visual display to be described in greater detail in connection with FIG. 4. The monitor/controller 10 aggregates the monitoring of the vehicle by displaying truck controller 20 function and monitoring on the display portion of the monitor/controller 10. The truck controller 20 can be mounted within the engine compartment of the cab 12 or, as depicted in FIG. 1, along a support rail of the load bed of the truck 14. A number of sensors and controllers are arrayed on or near the dump body 16 which will be described in greater detail in connection with FIG. 3.

Referring to FIG. 2, the integrated truck monitor and dump body controller 10 is located within the truck cab 12 in full view and reach of an operator. Mounted behind the truck cab 12 is a dump trailer 18. The integrated truck monitor and dump body controller 10 provides both sensor/monitor status of vehicle functions and dump trailer 18 status and control on a single interactive visual display to be described in greater detail in connection with FIG. 4. In this configuration the truck controller 20 and the trailer controller 22 are separated by function and sensor/monitoring between the truck cab 12 and the dump trailer 18. The truck controller 20 is mounted on a load support rail of the truck cab 12 and the trailer controller 22 is mounted on a support rail of the dump trailer 18. As with the dump truck 14, a number of sensors and controllers are arrayed on or near the truck cab 12 and the dump trailer 18 which will be described in greater detail in connection with FIG. 3.

Referring now to FIG. 3, integrated truck monitor and dump body controller 10 is depicted as being divided between an interactive visual display 24 and an integrated controller 26. The interactive visual display 24 is connected to the integrated controller 26 via bi-directional communications pathway 25. In the example of a dump body mounted to a truck frame, i.e., commonly referred to as a dump truck, the integrated controller 26 is connected directly to the truck controller 20. In the example of a dump body mounted to a pulled trailer, the integrated controller 26 is connected to the truck controller 20 and the dump trailer controller 22 by bi-directional communications pathways 21, 23, respectively. The truck controller 20 is connected to the truck body/engine interface 30 by a bi-directional interface 27. The bi-directional interface 27 also connects the truck controller 20 to a truck body inclination angle sensor 28, a truck hydraulic pressure sensor 32, an air suspension pressure sensor 34, and an air pressure supply sensor 36, all located on the truck body 14 or the truck cab 12. The trailer controller 22 is connected via bi-directional interface 29 to a dump trailer inclination angle sensor 38, a trailer air suspension pressure sensor 40, a trailer tailgate pressure sensor 42, a trailer hydraulic pressure sensor 44, and a trailer air pressure supply sensor 46. The trailer controller 22 is also connected via bi-directional interface 29 to a tarp position sensor and controller 48, a dump body sensor and controller 50, a tailgate sensor and lock controller 52, and a high lift sensor and controller 54. The various sensors/position controllers and/or status monitors are positioned in an appropriate array about the dump truck 14 and dump body 16 and the truck cab 12 and dump trailer 18 either in proximity to the sensed, monitored or controlled device or in line with the air or hydraulic pressure source for the specific device or apparatus, e.g., the air suspension system or the dump body hydraulic piston.

Continuing the description of the interactive visual display 24 there is shown in FIG. 4 a typical arrangement of sensors/monitors and controls for either the dump truck 14 and dump body 16 of the truck cab 12 and the dump trailer 18. To the right of the interactive display screen are a series of controls arranged vertically in a single column for selecting the display screen input and controlling one or more cameras connected to the controller interactive visual display 24 to be described more fully below. The interactive visual display 24 is connected to the various sensors/monitors and controllers through the integrated controller 26 and the bi-directional communications pathways 21, 23 to the truck controller 20 and the dump trailer controller 22. Via the bi-directional communications pathways 27, 29 the interactive visual display 24 can display the sensor status of individual devices, monitor the motion of operable devices, and control specific devices by causing the operable devices to function in the intended manner selected by the operator on the interactive visual display 24.

With reference to FIG. 4, a sample screen of the interactive visual display 24 for sensor and status monitoring and function control is shown. Starting at the upper left of the sample screen, an interactive control for the dump or tailgate 52a displays the status of the dump or tailgate, e.g., open/closed. In the example screen the dump or tailgate lock 52 is shown with the status of open with the indicator disk shifted to its maximum rightward position. The indicator disk can be illuminated as the tailgate lock 52 responds to the interactive command of the operator. To change the status of the tailgate lock 52 the operator touches the indicator disk and moves it to its maximum leftward position and as the control function is implemented the status will show a locked position illuminating the disk and the status advice when the action is completed.

The high lift gate on either a dump body 16 or a trailer dump body 18 (shown in phantom lines in FIG. 2) is similar to a standard tailgate in that it prevents the load from exiting the dump body, 16, 18. However, the high lift gate is capable of being lifted on reciprocating arms 55 outward and away from the bottom of the dump body 16, 18 and be raised above the sidewalls of the dump body 16, 18 to permit a greater amount of the load to be dumped in a shorter time. The interactive display/controller high lift gate 54a is shown in the position that the high lift gate remains closed even though the dump gate lock interactive display/controller 52a shows the dump gate lock in the open position. In order for the load to be dumped out from the dump body 16, 18 the high lift gate control 54a needs to be moved to its maximum rightward position in order to open and raise the high lift gate on the dump body 16, 18. When the requested action is completed the indicator disk is illuminated to display to the operator both the completion of the action and the status of the high lift gate.

In the example screen for the interactive visual display/controller 24 there are three axle controllers 56, 58, 60 that correlate to the standard two axles that exist on either a dump truck 14 or a dump trailer 18 and a third axle set that is used to either stabilize the dump body rear or to accommodate uneven terrain over which the dump truck 14 and dump trailer 18 must travel to deliver its load. It would be standard practice to have axles 2 and 3 lowered as shown by the Axle 2 and Axle 3 interactive display/controllers 56, 58 located across the bottom of the interactive visual/display controller 24. Axle 4 interactive display/controller 60 shows that axle 4 is in the lifted position with the operator able to change the position by moving the indicator to the leftmost position and the sensor displaying the status of lowered. The individual movement of the axles 2-4 are controlled by the overriding Dump Tridem controller 62 that permits operator control of the position of the axles when the Dump Tridem control 62 is engaged as shown by the indicator in the rightmost position. In this position, the operator is able to control the individual axles based upon the dump position or the terrain over which the vehicle must travel to deliver its load.

It is required in some instances to deliver a load that is protected from the elements by covering the load with a tarp that extends over the dump body 16 or trailer dump body 18. A tarp position sensor/control 48a is located at the top of the second column from the left of the interactive visual display/controller 24. The two indicator disks on the tarp position sensor/control 48a show the tarp status as open or closed. The respective disks are responsive to touch by the operator with the tarp responding to the respective command to close by unfurling from a rotating take-up rod or by retracting onto the take-up rod. In either case when the requested tarp motion is completed the respective indicator disk is illuminated to show the completed command status for the tarp.

A power take-off, or ‘PTO’, is an apparatus that provides mechanical power transferred from the vehicle engine to the hydraulic pumps for operating hydraulic equipment or mechanisms mounted on or to the dump truck 14 or the dump trailer 18. The PTO indicator 64 on the interactive visual display/control 24 is displayed at the top of the third column from the left with an indicator disk that is moveable from left to right to activate the PTO. Once activated, the indicator disk is illuminated showing the operator that the PTO is activated and operatively coupled to the hydraulic system for pressurization and mechanical operation of mounted equipment. When pressurized, the hydraulic systems on either the dump truck 14 or the dump trailer 18 become operable to raise and lower the dump body 16, 18. The ‘Pump Up’ control 66 located at the top of the far right column of the interactive visual display/control 24 is touched by the operator causing the hydraulic piston for raising and lowering the dump body 16, 18 to react by extending its piston raising the dump body from its horizontal position to an almost vertical position for discharging the load through the rear opening with the dump or tailgate unlocked and raised. When the load is completely discharged, the operator touches the ‘Pump Down’ control 68 causing the hydraulic piston to contract lowering the dump body 16, 18 to its horizontal position.

The final two indicators are system indicators that show the operator whether the vehicle is ready to be driven, i.e., the Travel Mode 70, or whether the vehicle is set for dumping the load, i.e., the Dump Mode 72. Each of the indicators, Travel Mode 70 and Dump Mode 72, are automatically illuminated when the conditions for travel or dumping are met by the various sensors on the vehicle. For example, the Dump Mode 72 would not illuminate if the tailgate lock sensor 52 did not indicate the lock was unlocked or if the tarp position sensor 48 did not indicate that the tarp was retracted and the dump body top open. Further, for the Travel Mode 70 to be illuminated, for example, the appropriate axles must be in the correct position, i.e., lowered or lifted, and the high lift gate sensor 54 must indicate that the gate is lowered and the tailgate or dump gate lock sensor 52 must indicate that the lock is engaged. For either the Travel Mode 70 or the Dump Mode 72 to be illuminated, all of the required conditions for vehicle movement or dump body motion must be met.

Along the right side of the interactive visual display 24 are a series of display input controls arrayed in a vertical column. The upper most display control 82 is the selector activating the sample interactive touch screen showing the function status and control functions for the truck and dump body. The remaining three controls 84, 86, 88 each are selective of a camera mounted to either the truck/trailer frame or the cab providing wide angle views for the operator of a desired set of functions. Camera 1, controlled for display by selector 84, provides a standard backup view function for the dump truck 14 with camera 84a mounted to the rearmost portion of the dump truck frame. The same selector will control camera 1 on the cab 12 with camera 84a mounted to the rearmost portion of the frame of the cab. Camera 2, controlled by selector 86, provides a standard backup view function for the dump trailer 18 with the camera 86a mounted to the rearmost portion of the dump trailer frame. The last selector 88 will control camera 3 that provides a view of the dump body 16, 18 with the camera 88a mounted atop the front wall of the dump body and protected by a transparent shield 90 so that the camera is protected as the operator views the loading and/or discharge of the load. Each of the selectors 82, 84, 86, 88 will illuminate, upon selection, and cause the interactive visual display 24 to show the interactive function/status screen or any camera view selected. The directional movement control 80 changes the interactive display screen 24 with an alternate or additional display screen providing a different set of status monitor and function controls. By selecting right or left, up or down, the operator can obtain an alternate display screen for displayed of other parameter of the truck and/or dump body for operator monitoring and control that are not shown on the sample display screen. The directional movement control 80 affords the operator the opportunity to alter the display to view one or more different sets of functions and/or status controls for monitoring the vehicle status, including, e.g., engine parameters, braking capacity, load balance, etc., for enhanced operation of the vehicle and/or trailer.

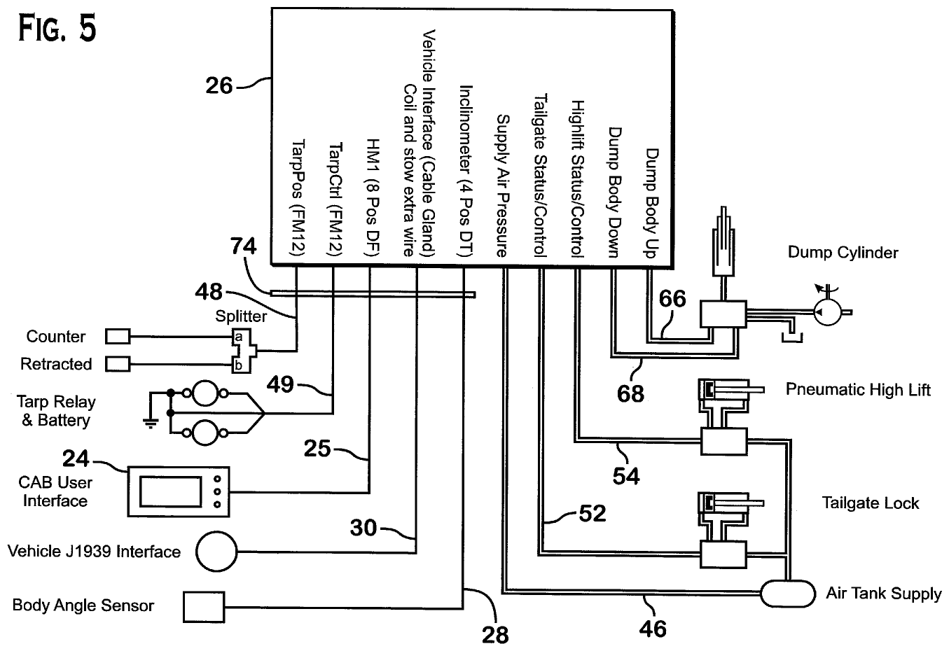

Referring to FIG. 5, the integrated controller 26 may be described in greater detail. The integrated controller 26 can be any of several computer-like devices, e.g., a programmable computer module [PCM] or a microprocessor coupled to an electrically alterable read only memory, either of which contain the operating parameters for the dump truck 14 and dump body 16 or the truck cab 12 and the trailer dump body 18. The integrated controller 26 is, as described above, connected to the various sensors and controllers through a series of bi-directional communications pathways 21, 23, 27, 29 and to the interactive visual display 24 via bi-directional communications pathway 25. Pathways 21, 23 provide interactive communication between the integrated controller 26 and the truck controller 20 and the trailer controller 22, respectively. For ease of understanding the several communications pathways and controllers 20, 22 have been omitted from FIG. 5 showing a direct communication pathway, by way of aggregated connector 74, between the integrated controller 26 and the device sensor or controller located on either the truck body 12, dump body 16 or dump trailer 18. As above in regard to the interactive visual display/controller 24, the integrated controller 26 is shown with an exemplary number of sensors and control command connections mostly corresponding to the status and control displays of the interactive visual display/controller 24.

Starting at the left the first two input/output communication sample connections provide the operator with the tarp position via a sensor/controller 48 located at or near the tarp control atop the front end of the dump trailer body 18. The first communication connection pathway 48 provides the tarp position to be displayed on the interactive visual display/controller 24. The second communication connection pathway 49 provides the operator with the control command to the tarp mechanism to unfurl or retract as requested by use of the interactive control display 48a for the operator on the interactive visual display/controller 24.

The next bi-directional connection is the bi-directional communications pathway 25 between the interactive visual display/controller 24 and the integrated controller 26. All of the commands and the various sensor/monitor information travels through this pathway between the interactive visual display/controller 24 and the integrated controller 26. The next bi-directional connection 30 communicates with the vehicle body/engine interface located in the engine compartment of the dump truck or truck cab 12. The last communication pathway is the monitor pathway truck body inclination sensor 28 that provides both side-to-side and front-to-back inclination of truck body deviation from absolute horizontal.

The examples noted above are merely exemplary of the total of all the interconnected sensor/monitor functions and controllers integrated from monitoring and control through the integrated controller 26. Those status positions and functions that also are connected to the integrated controller 26 through the truck controller 20 are hydraulic pressure sensor 32, air suspension pressure sensor 34 and air pressure supply sensor 36.

Arrayed about the trailer are a number of other sensor/monitors and controls that are connected to the integrated controller 26 through the trailer controller 22 via bi-directional communications pathways 23, 29. For ease of reference, refer to FIGS. 1, 2 as well as FIG. 5. The first of these example connections is the air pressure supply monitor 46 that provides the operator with a sensor readout that shows the pressurized status of the supply tank air pressure on the dump trailer 18. The next example connection in the example is the tailgate lock status sensor 52 that provides the operator with not only the status of the tailgate lock as either closed or open with the visual display 52 on the interactive visual display/controller 24, but also the capability to open and close the locking mechanism from the safety of the truck cab 12. The next example connection is the status and control of the high lift gate 54 that is displayed to the operator on the interactive visual display/controller 24 as the high lift gate status/control 54a. Both the tailgate locking mechanism and the high lift gate are pneumatically controlled with the requested action corresponding to the selected display command with the completed action communicated to the operator by the illumination of disk indicating the requested status.

The next two example connections exemplify the dump body commands for Pump Up 66 and Pump Down 68 relative to the hydraulic piston for controlling the position of the truck or trailer dump body 16, 18. The command for the activation of the hydraulic pump to pressurize the hydraulic piston for the positional displacement of the dump body 16 or the trailer dump body 18 is initiated by the operator touching the virtual Pump Up 66 command button on the interactive visual display/controller 24. This action effectuates the hydraulic pump pressurizing the hydraulic cylinder and raising the dump body 16 or the trailer dump body 18 to its load dumping position. In order to return the dump body 16 or trailer dump body 18 to its load carrying position in a substantially horizontal position, the operator touched the virtual Pump Down 68 button that causes the hydraulic fluid in the piston to drain back to the hydraulic fluid reservoir lowering the dump body 16 or trailer dump body 18 to its travel position of a substantially horizontal position.

The examples noted above are merely exemplary of the total of all the interconnected sensor/monitor functions and controllers integrated from monitoring and control through the integrated controller 26. Those status positions and functions that also are connected to the integrated controller 26 through the trailer controller 22 are the trailer inclination angle sensor 38, the trailer tailgate pressure sensor 42, the trailer hydraulic pressure sensor 44 and the trailer dump body sensor/controller 50.

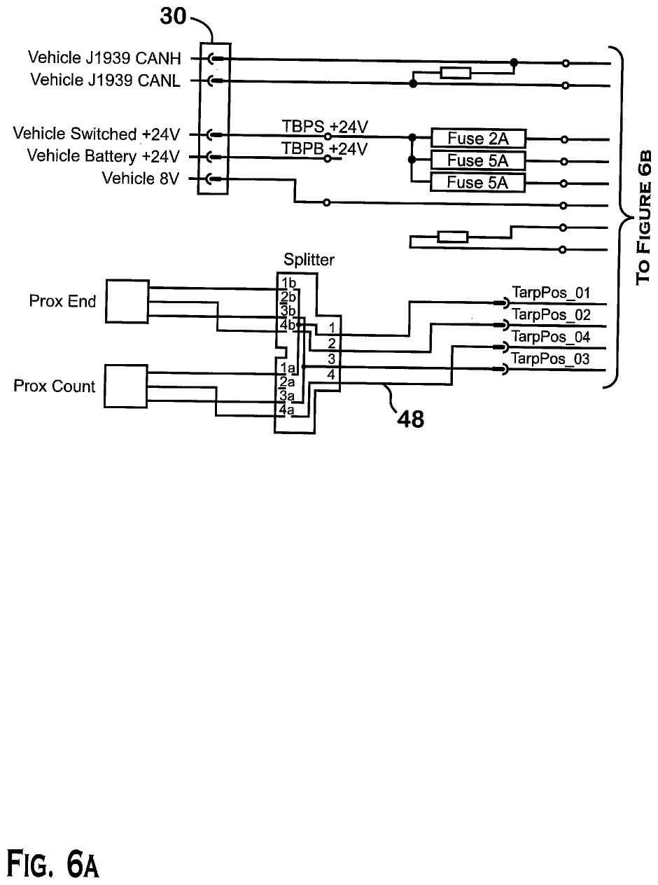

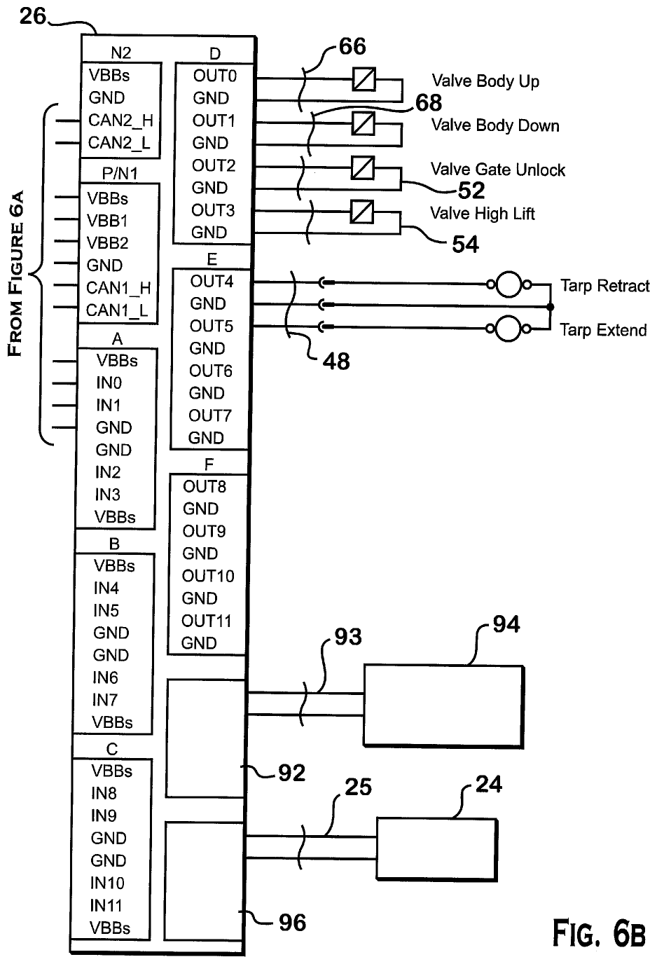

Referring now to FIGS. 6A and 6B, the integrated controller 26 as described above can include at least one computer-like devices, e.g., a programmable computer module [PCM] or a microprocessor 92 coupled to an electrically alterable read only memory 94 by bi-directional communications pathway 93. The electrically alterable read only memory 94 [EAROM] is capable of containing all of the software parameters for displaying, monitoring and controlling the various monitored and controlled functions of the vehicle and dump body. The PCM or microprocessor 92 performs the selected tasks based upon the operator selection of status monitor or function control based upon its operational software in coordination with the function control and monitoring software of the EAROM 94. The integrated visual display screen 24 is linked to the integrated controller 26 by bidirectional communications pathway 25 to an onboard video display driver 96 that operates in accordance with the selected display input 82, 84, 86 or 88 under the program control of the PCM or microprocessor 92.

The integrated controller may be connected to the several operable apparatus arrayed around the vehicle and/or dump body by a vehicle controller area network or ‘canbus’. As can be seen from FIG. 6, the canbus is utilized to connect the integrated controller 26 to the vehicle power source and to the vehicle engine parameter output through the vehicle body interface 30. Several connections are made through the various connection modules A-F of the integrated controller 26. Connection modules A, D and E are show, by way of example, for connecting the integrated controller 26 to the tarp monitoring and control for extension and retraction, as well as monitoring the status of the tarp position through tarp position sensor array 48 through connection modules E and A, respectively. Further examples controlled and monitored through connection module D are the dump body position, up or down, 66 and 68, respectively, and the dump gate lock position 52 and high lift status 54. The remaining unused portions of the connection modules A and D, and the other connection modules B, C and F, are connectable to other apparatus for status monitoring and function control beyond those provided above as examples of the interconnection of the PCM or microprocessor 92 to the various discussed apparatus arrayed about the vehicle and dump body through the integrated controller 26. The integrated controller 26 is also expandable to include as many connection modules as become necessary to be capable of monitoring and/or controlling the various apparatus necessary for safe operation of the vehicle and dump body by the operator.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. An apparatus for combining vehicle operational status and control in a single interactive sensing, control and display unit comprising:
said vehicle being a truck with dump body or a truck with attached dump trailer;
an interactive visual display having one or more screens for displaying for an operator vehicle parametric information including both truck and dump body or dump trailer operational status, selectable control functions for various operable equipment on the dump body or dump trailer, and selectable camera views of an immediate area surrounding the vehicle and the dump body or dump trailer;
a special purpose computing device for collecting a plurality of sensor information from said vehicle including operating parameters of said truck and operating parameters for said dump body or dump trailer and displaying the sensor and operating parameter status on the interactive visual display screen and for controlling selectable functions of various operable equipment on the dump body or dump trailer from visual controls displayed on one or more screens of said interactive visual display.

2. The interactive visual display of claim 1, wherein the operator can select for viewing the one or more screens for monitoring vehicle parameters and sensor information, controlling dump body or dump trailer functions, and camera views.

3. The interactive visual display of claim 2, wherein the one or more screens available for viewing may be arranged to display vehicle parameter and sensor information and dump body or dump trailer control functions on a single screen.

4. The interactive visual display of claim 2, wherein the one or more screens available for viewing may be arranged to display vehicle parameter and sensor information, dump body or dump trailer control functions, and one or more camera views on a single screen.

5. The plurality of sensor information collected from said vehicle including operating parameters of said truck of claim 1 selected from the group consisting of body angle sensor, air suspension pressure sensor, air supply pressure sensor, and hydraulic pressure sensor.

6. The plurality of sensor information from said vehicle including operating parameters for said dump body or dump trailer of claim 1 selected from the group consisting of dump body or trailer angle sensor, air suspension pressure sensor, air supply pressure sensor, hydraulic pressure sensor, tailgate pressure sensor, high lift tailgate sensor, tailgate lock position sensor, dump body position sensor, load cover position sensor, and one or more axle position sensors.

7. An apparatus for combining vehicle operational status and control in a single interactive sensing, control and display unit comprising:
said vehicle being a truck with dump body or a truck with attached dump trailer;
an interactive visual display having one or more screens for displaying for an operator vehicle parametric information including both truck and dump body or dump trailer operational status, selectable control functions for various operable equipment on the dump body or dump trailer, and selectable camera views of an immediate area surrounding the vehicle and the dump body or dump trailer, said operator can select for viewing the one or more screens for monitoring vehicle parameters and sensor information, controlling dump body or dump trailer functions, and camera views;
a special purpose computing device for collecting a plurality of sensor information from said vehicle including operating parameters of said truck and operating parameters for said dump body or dump trailer and displaying the sensor and operating parameter status on the interactive visual display screen and for controlling selectable functions of various operable equipment on the dump body or dump trailer from visual controls displayed on one or more screens of said interactive visual display.

8. The interactive visual display of claim 7, wherein the one or more screens available for viewing may be arranged to display vehicle parameter and sensor information and dump body or dump trailer control functions on a single screen.

9. The interactive visual display of claim 7, wherein the one or more screens available for viewing may be arranged to display vehicle parameter and sensor information, dump body or dump trailer control functions, and one or more camera views on a single screen.

10. The plurality of sensor information collected from said vehicle including operating parameters of said truck of claim 7 selected from the group consisting of body angle sensor, air suspension pressure sensor, air supply pressure sensor, and hydraulic pressure sensor.

11. The plurality of sensor information from said vehicle including operating parameters for said dump body or dump trailer of claim 7 selected from the group consisting of dump body or trailer angle sensor, air suspension pressure sensor, air supply pressure sensor, hydraulic pressure sensor, tailgate pressure sensor, high lift tailgate sensor, tailgate lock position sensor, dump body position sensor, load cover position sensor, and one or more axle position sensors.
